(19) United States
(12) Patent Application Publication
(10) Pub. No.: US 2017/0143061 A1
(43) Pub. Date: May 25, 2017

(54) ILLUMINATED GARMENT

(71) Applicant: Under Cover Bridal Holdings LLC, Gardena, CA (US)

(72) Inventor: Harlan Wilkie, Gardena, CA (US)

(21) Appl. No.: 15/141,705

(22) Filed: Apr. 28, 2016

Related U.S. Application Data
(60) Provisional application No. 62/154,042, filed on Apr. 28, 2015.

(51) Int. Cl. A41D 27/08; F21L 4/08; H05B 33/08; F21V 31/00; F21V 33/00; F21V 23/00; F21V 8/00

(52) U.S. Cl. CPC A41D 27/085; F21V 23/003; F21L 4/08; G02B 6/0005; F21V 31/005; F21V 33/0008; H05B 33/0857; H05B 33/0845; F21Y 2115/10

(57) ABSTRACT

Garments having illuminated technology which is durable, easy to use, and maintain. The garments having illuminated technology which may get wet or be washed. The illuminated technology that will function in a plurality of fabric, materials, and environments. The illuminated technology may be operably attached to garments during production or manufacture or, may be integrated post-production.

Batteries accidently left in an EL wire driver may destroy the garment and system electronics. Often, users will hear a high pitched noise from the inversion of electricity. Also, phosphor has a half-life 2800 to 3000 hours. Consequently, the EL wire will eventually stop illuminating.

An illuminated technology that changes color on demand for garments, accessories, home and industry illumination, water illumination, automotive interiors/exteriors, amongst others that is durable, easy to use, and maintain is needed.

### SUMMARY OF THE INVENTION

It is an object of this invention to provide garments having illuminated technology which is durable, easy to use, and maintain. It is another object of this invention to provide garments having illuminated technology which can get wet or be washed. It is another object of this invention to provide illuminated technology that will function in a plurality of fabric, materials, and environments. The illuminated technology may be operably attached to garments during production or manufacture or, may be integrated post-production.

### BRIEF DESCRIPTION OF THE DRAWINGS

Other features and advantages of the present invention will become apparent in the following detailed descriptions of the preferred embodiment with reference to the accompanying drawings, of which:

FIG. 1 is a perspective view of an exemplary plastic optical fiber;

FIG. 2 is a perspective view of an exemplary plastic optical fiber having a tail;

FIG. 3 is a front perspective view of an illuminated garment;

FIG. 4A is an exemplary driver circuit;

FIG. 4B is an exemplary driver circuit;

FIG. 5 is a flow chart showing how LED lights may be controlled.

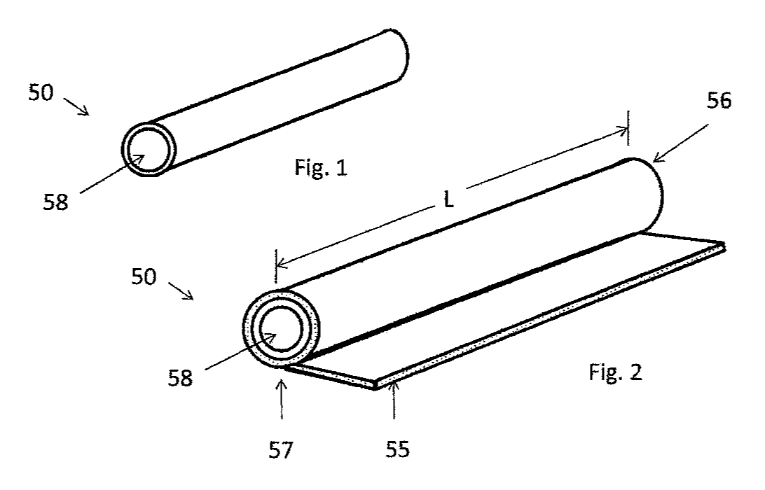

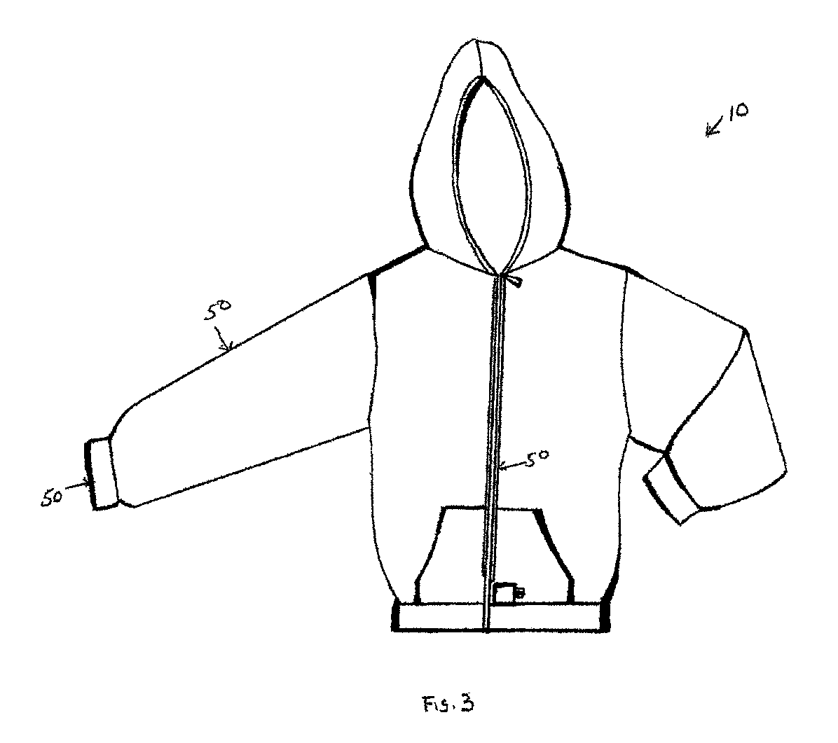

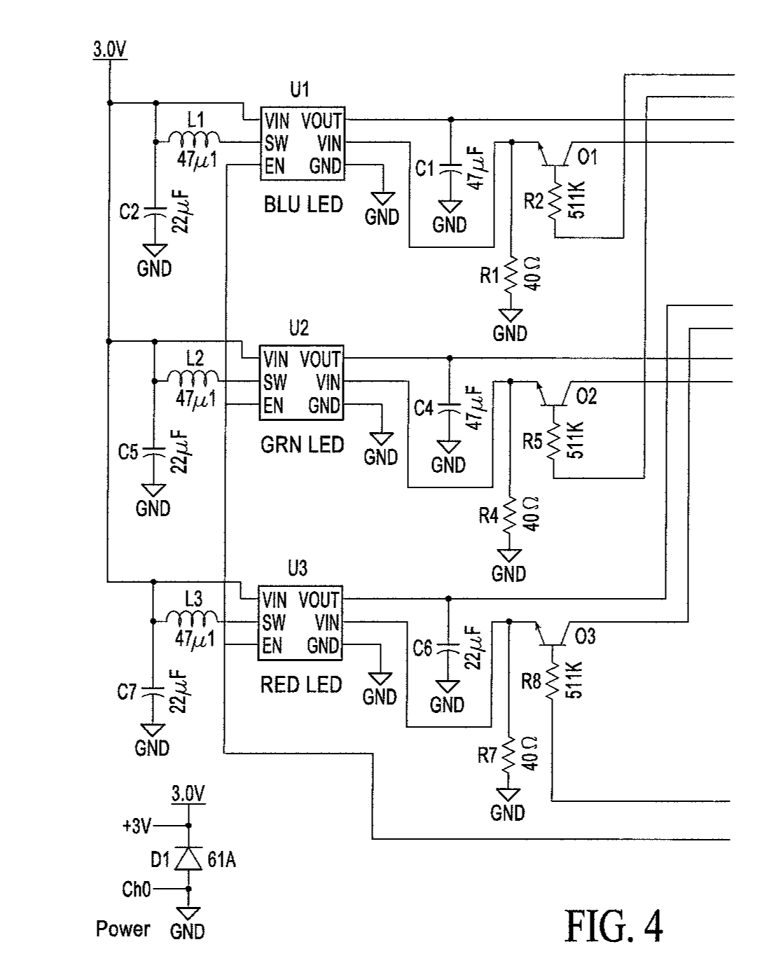

### DETAILED DESCRIPTION OF THE INVENTION

In the following detailed description, reference is made to the accompanying drawings, which form a part hereof. In the drawings, the use of similar or the same symbols in different drawings typically indicates similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or

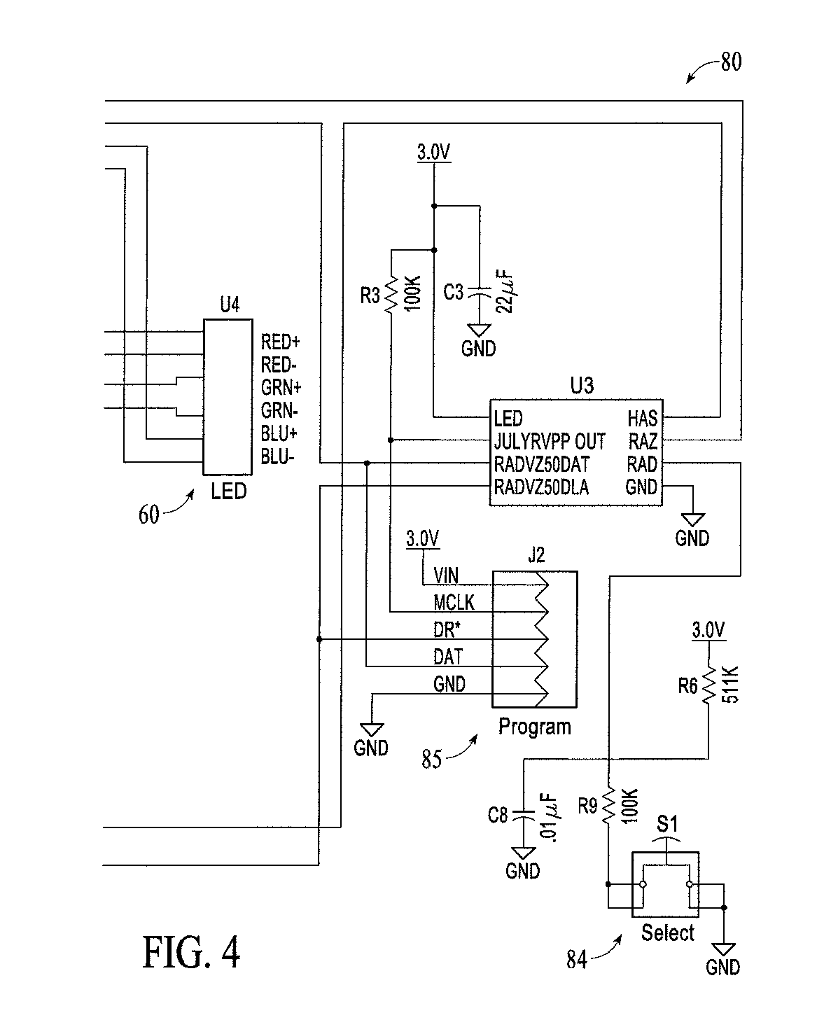

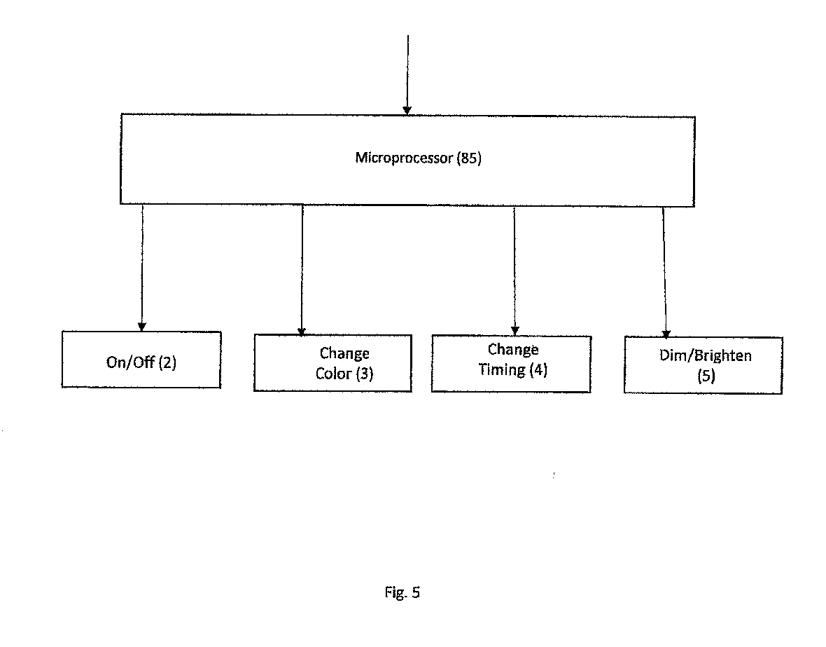

Referring to FIGS. 4A, 4B and 5, according to one embodiment, a POF (50) is operably attached to and is illuminated by at least one LED (60). According to another embodiment, a POF (50) is illuminated by more than one LED (60). It will be appreciated that the LED (60) may represent any color or multiple colors. According to one embodiment, at least one end (57) of a POF (50) is cut and made smooth and the at least one LED (60) is operably attached to the smooth end (57). According to one embodiment, the at least one LED (60) is attached to the smooth end (57) with glue, adhesive, or mechanical connections. According to one embodiment, a reflective cap (56) may be placed on the end opposite to the smooth end (57).

According to one embodiment, the at least one LED (60) is waterproofed. According to one embodiment, waterproofing means that the smooth end (57) and the LED (60) are enclosed in a polymer, epoxy or other encasement/housing.

An exemplary programmable driver (80) is shown in FIG. 4. According to one embodiment, the driver (80) is comprised of a processor (85). Referring to FIG. 5, according to one embodiment, the driver (80) allows a user (1) to turn the at least one LED (60) on/off (2), change the color profile (3) of the at least one LED (60), dim/brighten (5) the at least one LED (60), allow for varying intermittent sessions of illuminations (4) such as; flash, strobe, pulse, amongst others. According to one embodiment, the processor (85) may be controlled by smart devices via a Bluetooth or other similar protocol, a capacitance or other electric switch, a mechanical switch, or radio signal, amongst others. (84) According to one embodiment, the processor (85) may be programmed by the user via a software/firmware program, application, website, mobile device, or a combination thereof According to one embodiment, the driver (80) is comprised of rechargeable batteries. According to one embodiment, the rechargeable batteries are charged via a USB port.

What is claimed is:

1. A garment operably attached to at least one plastic optical fiber where, the at least one plastic optical fiber is illuminated by at least one LED where the LED is controlled by a driver.

2. The garment according to claim 1 where the driver responds to Bluetooth protocol, a capacitance switch, a mechanical switch, an analog switch, a digital switch, a radio signal, or a combination thereof.

3. The garment according to claim 2 where the driver turns the LED on/off.

4. The garment according to claim 2 where the driver allows intermittent sessions of illumination.

5. The garment according to claim 2 where the driver changes the color illuminated through the plastic optical fiber.
